(19) United States
(12) Patent Application Publication
(10) Pub. No.: US 2003/0104929 A1
(43) Pub. Date: Jun. 5, 2003

(54) Polymerisation catalyst

(76) Inventors: Stuart Jame McTavish, Sutton (GB); Marc John Payne, Eastrington (GB)

Correspondence Address: Finnegan, Henderson, Farabow,, Garrett & Dunner, L.L.P., 1300 I Street, N.W., Washington, DC, 20005-3315, US

(21) Appl. No.: 10/106,762

(22) Filed: Mar. 27, 2002

Related U.S. Application Data
(63) Continuation of application No. PCT/GB00/03487, filed on Sep. 11, 2000.

(30) Foreign Application Priority Data
Sep. 29, 1999 (GB) 9923072.4

(51) Int. Cl. C08F 2/00; B01J 31/00; C07F 15/00

(52) U.S. Cl. 502/150; 526/172; 526/88; 526/901; 526/904; 526/905; 502/152; 502/153; 502/154; 502/155; 502/167; 546/2

(57) ABSTRACT

A nitrogen containing transition metal complex having Formula (I),

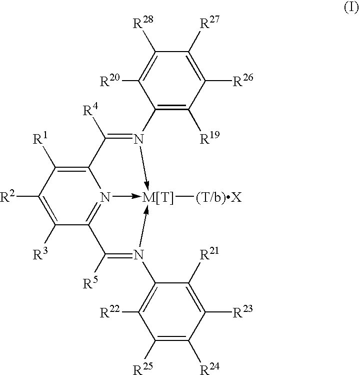

wherein M is Fe[II], Fe[III], Co[I], Co[II], Co[III], Mn[I], Mn[II], Mn[III], Mn[IV], Ru[II], Ru[III] or Ru[IV]; X represents an atom or group bonded to the transition metal M; T is the oxidation state of the transition metal M and b is the valency of the atom or group X; R¹, R², R³, R⁴, R⁵, R¹⁹, R²⁰, R²¹, R²², R²³, R²⁴, R²⁵, R²⁶, R²⁷ and R²⁸ are independently selected from hydrogen, halogen, hydrocarbyl, substituted hydrocarbyl, heterohydrocarbyl or substituted heterohydrocarbyl; when any two or more of R¹, R², R³, R⁴ and R⁵ and are hydrocarbyl, substituted hydrocarbyl, heterohydrocarbyl or substituted heterohydrocarbyl, two or more can be linked to form one or more cyclic substituents, and at least one of R⁴ and R⁵ is a hydrocarbyl group having at least two carbon atoms.

The present invention relates to transition metal complex compounds, to polymerisation catalysts based thereon and to their use in the polymerisation and copolymerisation of olefins.

The use of certain transition metal compounds to polymerise 1-olefins, for example, ethylene or propylene, is well established in the prior art. The use of Ziegler-Natta catalysts, for example, those catalysts produced by activating titanium halides with organometallic compounds such as triethylaluminium, is fundamental to many commercial processes for manufacturing polyolefins. Over the last twenty or thirty years, advances in the technology have led to the development of Ziegler-Natta catalysts which have such high activities that olefin polymers and copolymers containing very low concentrations of residual catalyst can be produced directly in commercial polymerisation processes. The quantities of residual catalyst remaining in the produced polymer are so small as to render unnecessary their separation and removal for most commercial applications. Such processes can be operated by polymerising the monomers in the gas phase, or in solution or in suspension in a liquid hydrocarbon diluent. Polymerisation of the monomers can be carried out in the gas phase (the “gas phase process”), for example by fluidising under polymerisation conditions a bed comprising the target polyolefin powder and particles of the desired catalyst using a fluidising gas stream comprising the gaseous monomer. In the so-called “solution process” the (co)polymerisation is conducted by introducing the monomer into a solution or suspension of the catalyst in a liquid hydrocarbon diluent under conditions of temperature and pressure such that the produced polyolefin forms as a solution in the hydrocarbon diluent. In the “slurry process” the temperature, pressure and choice of diluent are such that the produced polymer forms as a suspension in the liquid hydrocarbon diluent. These processes are generally operated at relatively low pressures (for example 10-50 bar) and low temperature (for example 50 to 150° C.).

In recent years the use of certain metallocene catalysts (for example biscyclopentadienylzirconiumdichloride activated with alumoxane) has provided catalysts with potentially high activity. However, metallocene catalysts of this type suffer from a number of disadvantages, for example, high sensitivity to impurities when used with commercially available monomers, diluents and process gas streams, the need to use large quantities of expensive alumoxanes to achieve high activity, and difficulties in putting the catalyst on to a suitable support.

WO99/12981 discloses that ethylene and other 1-olefins may be polymerised by contacting it with certain late transition metal complexes of selected 2,6-pyridinecarboxaldehydebis (imines) and 2,6-diacylpyridinebis (imines).

An object of the present invention is to provide a novel catalyst suitable for polymerising and oligomerising monomers, for example, olefins such as α-olefins containing from 2 to 20 carbon atoms, and especially for polymerising ethylene alone, propylene alone, or for copolymerising ethylene or propylene with other 1-olefins such as C₂₋₂₀ α-olefins. A further object of the invention is to provide an improved process for the polymerisation of olefins, especially of ethylene alone or the copolymerisation of ethylene or propylene with higher 1-olefins to provide homopolymers and copolymers having controllable molecular weights. For example, using the catalysts of the present invention there can be made a wide variety of products such as, for example, liquid polyolefins, oligomers, linear α-olefins, branched α-olefins, resinous or tacky polyolefins, solid polyolefins suitable for making flexible film and solid polyolefins having high stiffness.

The present invention provides a nitrogen containing transition metal complex having the following Formula (I)

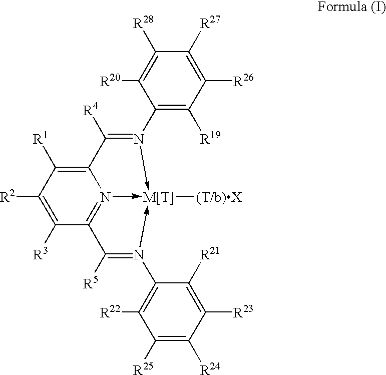

wherein M is Fe[II], Fe[III], Co[I], Co[II], Co[III], Mn[I], Mn[II], Mn[III], Mn[IV], Ru[II], Ru[III] or Ru[IV]; X represents an atom or group covalently or ionically bonded to the transition metal M; T is the oxidation state of the transition metal M and b is the valency of the atom or group X; R¹, R², R³, R⁴, R⁵, R¹⁹, R²⁰, R²¹, R²², R²³, R²⁴, R²⁵, R²⁶, R²⁷ and R²⁸ are independently selected from hydrogen, halogen, hydrocarbyl, substituted hydrocarbyl, heterohydrocarbyl or substituted heterohydrocarbyl; when any two or more of R¹ R², R³, R⁴ and R⁵ and are hydrocarbyl, substituted hydrocarbyl, heterohydrocarbyl or substituted heterohydrocarbyl, said two or more can be linked to form one or more cyclic substituents;

characterised in that at least one of R⁴ and R⁵ is a hydrocarbyl group having at least two carbon atoms.

We have found that polymers produced using such compounds as catalysts can have different properties from those produced using known catalysts such as disclosed in WO99/12981; in particular, higher polydispersities (M_{w}/Mₙ) can be obtained, leading to improved processing properties.

Preferably at least one of R⁴ and R⁵ has from 2 to 12 carbon atoms, and more preferably from 3 to 10 carbon atoms.

R¹, R², R³, R⁴, R⁵, R¹⁹, R²⁰, R²¹, R²², R²³, R²⁴, R²⁵, R²⁶ R²⁷ and R ²⁸ are preferably independently selected from hydrogen and C₁ to C₈ hydrocarbyl, for example, methyl, ethyl, n-propyl, n-butyl, n-hexyl, n-octyl, phenyl and benzyl.

Preferably at least one and more preferably both of R⁴ and R⁵ is ethyl, isopropyl, t-butyl, phenyl, 2,4-dimethyl phenyl or CH₂CH₂Ph.

In one embodiment R²⁴ and R²⁷ are either both halogen or at least one of them has two or more carbon atoms. In the case where at least one of R²⁴ and R²⁷ contains two carbon atoms, they preferably have from 2 to 10 carbon atoms, more preferably from 4 to 8 carbon atoms. If desired one, but not both, of the groups R²⁴ and R²⁷ can be selected from hydrogen or methyl. However, it is preferred that both R²⁴ and R²⁷ contain from 2 to 10 carbon atoms, most preferably from 4 to 8 carbon atoms. R²⁴ and R²⁷ are preferably independently selected from ethyl, n-propyl, iso-propyl, n-butyl, sec-butyl, tert.-butyl, n-pentyl, neopentyl, n-hexyl, 4-methylpentyl, n-octyl, phenyl and benzyl. Most preferably in this case R²⁴ and R²⁷ are both tertiary butyl. Alternatively, one of R²⁴ and R²⁷ contains at least two carbon atoms and the other is halogen, preferably fluoro.

Preferably at least one of R¹⁹, R²⁰, R²¹ and R²² is hydrocarbyl, substituted hydrocarbyl, heterohydrocarbyl or substituted heterohydrocarbyl. More preferably at least one of R¹⁹ and R²⁰, and at least one of R²¹ and R²², is hydrocarbyl, substituted hydrocarbyl, heterohydrocarbyl or substituted heterohydrocarbyl. Most preferably R¹⁹, R²⁰, R²¹ and R²² are all independently selected from hydrocarbyl, substituted hydrocarbyl, heterohydrocarbyl or substituted heterohydrocarbyl. R¹⁹, R²⁰, R²¹ and R²² are preferably independently selected from methyl, ethyl, n-propyl, iso-propyl, n-butyl, sec-butyl, tert.-butyl, n-pentyl, neopentyl, n-hexyl, 4-methylpentyl, n-octyl, phenyl and benzyl. However in the case when R²⁴ and R²⁷ are both halogen, it is preferred that one of R²¹ and R²² and also one of R¹⁹ and R²⁰ is hydrogen.

Preferably R²³, R²⁵, R²⁶ and R²⁸ are all hydrogen.

In the nitrogen-containing complex of the present invention the transition metal M is preferably Fe(II), Fe(III) or Co(II).

Each of the nitrogen atoms is coordinated to the transition metal M by a “dative” bond, ie a bond formed by donation of a lone pair of electrons from the nitrogen atom. The remaining bonds on each nitrogen atom are covalent bonds formed by electron sharing between the nitrogen atoms and the organic ligand as shown in the defined formula for the transition metal complex illustrated above.

The atom or group represented by X in the compounds of Formula (I) can be, for example, selected from halide, sulphate, nitrate, thiolate, thiocarboxylate, BF₄⁻, PF₆⁻, hydride, hydrocarbyloxide, carboxylate, hydrocarbyl, substituted hydrocarbyl and heterohydrocarbyl, or β-diketonates. Examples of such atoms or groups are chloride, bromide, methyl, ethyl, propyl, butyl, octyl, decyl, phenyl, benzyl, methoxide, ethoxide, isopropoxide, tosylate, triflate, formate, acetate, phenoxide and benzoate. Preferred examples of the atom or group X in the compounds of Formula (I) are halide, for example, chloride, bromide; hydride; hydrocarbyloxide, for example, methoxide, ethoxide, isopropoxide, phenoxide; carboxylate, for example, formate, acetate, benzoate; hydrocarbyl, for example, methyl, ethyl, propyl, butyl, octyl, decyl, phenyl, benzyl; substituted hydrocarbyl; heterohydrocarbyl; tosylate; and triflate. Preferably X is selected from halide, hydride and hydrocarbyl. Chloride is particularly preferred

It is found that using the complexes of the present invention for polymerisation of ethylene or copolymeristion of ethylene and another olefin that the molecular weight distribution of the resulting polymer is broader and the MFR higher compared to polymers produced using complexes disclosed in earlier patents.

Examples of complexes of the present invention include 2,6bis[1-(2,4,6 trimethylphenylimine)3-phenylpropyl]pyridine iron dichloride, 2,6bis[1-(2,6 diisopropylphenylimine)3-phenylpropyl]pyridine iron dichloride, 2,6bis[1-(2,4,6 trimethylphenylimine)propyl)pyridine iron dichloride, 2,6bis[1-(2,6diisopropylphenylimine) propyl]pyridine iron dichloride, 2,6bis[1-(2,4,6 trimethylphenylimine)2-methylpropyl]pyridine iron dichloride, 2,6bis[1-(2,6 diisopropylphenylimine)2-methylpropyl]pyridine iron dichloride, 2,6bis[1-(2,6 dimethyl,4-tertbutylphenylimine) 3-phenylpropyl]pyridine iron dichloride, 2,6bis[1-(2,6 dimethyl,4-bromophenylimine) 3-phenylpropyl]pyridine iron dichloride, 2,6bis[1-(2,4,6 trimethylphenylimine) 3-phenylpropyl]pyridine iron dibromide, 2,6bis[1-(2,6 diisopropylphenylimine) 3-phenylpropyl]pyridine iron dibromide, 2-[1-(2,4,6 trimethylphenylimine) 3-phenylpropyl]- 6-[1-(2,4,6 trimethylphenylimine) ethyl] pyridine iron dichloride, 2-[1-(2,6 diisopropylphenylimine) 3-phenylpropyl]-6-[(2,6 diisopropylphenylimine)ethyl]pyridine iron dichloride, 2,6bis[1-(2,4,6 trimethylphenylimine) 3-phenylpropyl]pyridine cobalt dichloride, 2,6bis[1-(2,6 diisopropylphenylimine) 3-phenylpropyl]pyridine cobalt dichloride, 2,6bis[1-(2,4,6 trimethylphenylimine) propyl]pyridine cobalt dichloride, 2,6bis[1-(2,6 diisopropylphenylimine) propyl]pyridine cobalt dichloride, 2,6bis[1 -(2,4,6 trimethylphenylimine)2-methylpropyl]pyridine cobalt dichloride, 2,6bis[1-(2,6 diisopropylphenylimine) 2-methylpropyl]pyridine cobalt dichloride, 2,6-bis-[1-(2,4,6-trimethylphenylimino)-1-(2,4-dimethylphenyl)methyl]pyridine iron dichloride, 2,6-bis-[1-(2,4,6-trimethylphenylimino)-1-phenylmethyl]pyridine iron dichloride.

The present invention further provides a polymerisation catalyst comprising

(1) a compound having the Formula (I) as hereinbefore defined, and

(2) an activating quantity of at least one activator compound.

The activator compound for the catalyst of the present invention is suitably selected from organoaluminium compounds and hydrocarbylboron compounds. Suitable organoaluminium compounds include compounds of the formula AlR₃, where each R is independently C₁-C₁₂ alkyl or halo. Examples include trimethylaluminium (TMA), triethylaluminium (TEA), tri-isobutylaluminium (TIBA), tri-n-octylaluminium, methylaluminium dichloride, ethylaluminium dichloride, dimethylaluminium chloride, diethylaluminium chloride, ethylaluminiumsesquichloride, methylaluminiumsesquichloride, and alumoxanes. Alumoxanes are well known in the art as typically the oligomeric compounds which can be prepared by the controlled addition of water to an alkylaluminium compound, for example trimethylaluminium. Such compounds can be linear, cyclic or mixtures thereof. Commercially available alumoxanes are generally believed to be mixtures of linear and cyclic compounds. The cyclic alumoxanes can be represented by the formula [R¹⁶AlO]ₛ, and the linear alumoxanes by the formula R¹⁷(R¹⁸AlO)ₛ wherein s is a number from about 2 to 50, and wherein R¹⁶, R¹⁷, and R¹⁸ represent hydrocarbyl groups, preferably C₁ to C₆ alkyl groups, for example methyl, ethyl or butyl groups. Alkylalumoxanes such as methylalumoxane (MAO) are preferred.

Mixtures of alkylalumoxanes and trialkylaluminium compounds are particularly preferred, such as MAO with TMA or TIBA. In this context it should be noted that the term “alkylalumoxane” as used in this specification includes alkylalumoxanes available commercially which may contain a proportion, typically about 10 wt %, but optionally up to 50 wt %, of the corresponding trialkylaluminium; for instance, commercial MAO usually contains approximately 10 wt % trimethylaluminium (TMA), whilst commercial MMAO contains both TMA and TIBA. Quantities of alkylalumoxane quoted herein include such trialkylaluminium impurities, and accordingly quantities of trialkylaluminium compounds quoted herein are considered to comprise compounds of the formula AlR₃ additional to any AlR₃ compound incorporated within the alkylalumoxane when present.

Examples of suitable hydrocarbylboron compounds are boroxines, trimethylboron, triethylboron, dimethylphenylammoniumtetra(phenyl)borate, trityltetra(phenyl)borate, triphenylboron, dimethylphenylammonium tetra(pentafluorophenyl)borate, sodium tetrakis[(bis-3,5-trifluoromethyl)phenyl]borate, H⁺(OEt₂)[(bis-3,5-trifluoromethyl)phenyl]borate, trityltetra(pentafluorophenyl)borate and tris(pentafluorophenyl) boron.

In the preparation of the catalysts of the present invention the quantity of activating compound selected from organoaluminium compounds and hydrocarbylboron compounds to be employed is easily determined by simple testing, for example, by the preparation of small test samples which can be used to polymerise small quantities of the monomer(s) and thus to determine the activity of the produced catalyst. It is generally found that the quantity employed is sufficient to provide 0.1 to 20,000 atoms, preferably 1 to 2000 atoms of aluminium or boron per atom of metal M in the compound of Formula (I).

An alternative class of activators comprise salts of a cationic oxidising agent and a non-coordinating compatible anion. Examples of cationic oxidising agents include: ferrocenium, hydrocarbyl-substituted ferrocenium, Ag⁺, or Pb²⁺. Examples of non-coordinating compatible anions are BF₄⁻, SbCl₆⁻, PF₆⁻, tetrakis(phenyl)borate and tetrakis(pentafluorophenyl)borate.

A further aspect of the present invention provides a polymerisation catalyst system comprising (1) a compound having the Formula (I) as hereinbefore defined, including all the compounds excluded above, (2) an activating quantity of at least one activator compound as defined above, and (3) a neutral Lewis base.

Neutral Lewis bases are well known in the art of Ziegler-Natta catalyst polymerisation technology. Examples of classes of neutral Lewis bases suitably employed in the present invention are unsaturated hydrocarbons, for example, alkenes (other than 1-olefins) or alkynes, primary, secondary and tertiary amines, amides, phosphoramides, phosphines, phosphites, ethers, thioethers, nitrites, carbonyl compounds, for example, esters, ketones, aldehydes, carbon monoxide and carbon dioxide, sulphoxides, sulphones and boroxines Although 1-olefins are capable of acting as neutral Lewis bases, for the purposes of the present invention they are regarded as monomer or comonomer 1-olefins and not as neutral Lewis bases per se. However, alkenes which are internal olefins, for example, 2-butene and cyclohexene are regarded as neutral Lewis bases in the present invention. Preferred Lewis bases are tertiary amines and aromatic esters, for example, dimethylaniline, diethylaniline, tributylamine, ethylbenzoate and benzylbenzoate. In this particular aspect of the present invention, components (1), (2) and (3) of the catalyst system can be brought together simultaneously or in any desired order. However, if components (2) and (3) are compounds which interact together strongly, for example, form a stable compound together, it is preferred to bring together either components (1) and (2) or components (1) and (3) in an initial step before introducing the final defined component. Preferably components (1) and (3) are contacted together before component (2) is introduced. The quantities of components (1) and (2) employed in the preparation of this catalyst system are suitably as described above in relation to the catalysts of the present invention. The quantity of the neutral Lewis Base [component (3)] is preferably such as to provide a ratio of component (1):component (3) in the range 100:1 to 1:1000, most preferably in the range 1:1 to 1:20. Components (1), (2) and (3) of the catalyst system can brought together, for example, as the neat materials, as a suspension or solution of the materials in a suitable diluent or solvent (for example a liquid hydrocarbon), or, if at least one of the components is volatile, by utilising the vapour of that component. The components can be brought together at any desired temperature. Mixing the components together at room temperature is generally satisfactory. Heating to higher temperatures e.g. up to 120° C. can be carried out if desired, e.g. to achieve better mixing of the components. It is preferred to carry out the bringing together of components (1), (2) and (3) in an inert atmosphere (e.g. dry nitrogen) or in vacuo. If it is desired to use the catalyst on a support material (see below), this can be achieved, for example, by preforming the catalyst system comprising components (1), (2) and (3) and impregnating the support material preferably with a solution thereof, or by introducing to the support material one or more of the components simultaneously or sequentially. If desired the support material itself can have the properties of a neutral Lewis base and can be employed as, or in place of, component (3). An example of a support material having neutral Lewis base properties is poly(aminostyrene) or a copolymer of styrene and aminostyrene (ie vinylaniline).

The catalysts of the present invention can if desired comprise more than one of the defined compounds. Alternatively, the catalysts of the present invention can also include one or more other types of transition metal compounds or catalysts, for example, nitrogen containing catalysts such as those described in our copending applications WO 99/12981 or GB 9903402.7. Examples of such other catalysts include 2,6-diacetylpyridinebis(2,4,6-trimethyl anil)FeCl₂.

The catalysts of the present invention can also include one or more other types of catalyst, such as those of the type used in conventional Ziegler-Natta catalyst systems, metallocene-based catalysts, monocyclopentadienyl- or constrained geometry based catalysts, or heat activated supported chromium oxide catalysts (e.g. Phillips-type catalyst).

The catalysts of the present invention can be unsupported or supported on a support material, for example, silica, alumina, MgCl₂ or zirconia, or on a polymer or prepolymer, for example polyethylene, polypropylene, polystyrene, or poly(aminostyrene).

If desired the catalysts can be formed in situ in the presence of the support material, or the support material can be pre-impregnated or premixed, simultaneously or sequentially, with one or more of the catalyst components. The catalysts of the present invention can if desired be supported on a heterogeneous catalyst, for example, a magnesium halide supported Ziegler Natta catalyst, a Phillips type (chromium oxide) supported catalyst or a supported metallocene catalyst. Formation of the supported catalyst can be achieved for example by treating the transition metal compounds of the present invention with alumoxane in a suitable inert diluent, for example a volatile hydrocarbon, slurrying a particulate support material with the product and evaporating the volatile diluent. The produced supported catalyst is preferably in the form of a free-flowing powder. The quantity of support material employed can vary widely, for example from 100,000 to 1 grams per gram of metal present in the transition metal compound.

The present invention further provides a process for the polymerisation and copolymerisation of 1-olefins, comprising contacting the monomeric olefin under polymerisation conditions with the polymerisation catalyst or catalyst system of the present invention. A preferred process comprises the steps of:

a) preparing a prepolymer-based catalyst by contacting one or more 1-olefins with a catalyst system, and

b) contacting the prepolymer-based catalyst with one or more 1-olefins, wherein the catalyst system is as defined above.

The present invention also encompasses as another aspect the use of a complex as defined above as a catalyst for the polymerisation of 1-olefins.

In the text hereinbelow, the term “catalyst” is intended to include “catalyst system” as defined previously and also “prepolymer-based catalyst” as defined above.

The polymerisation conditions can be, for example, solution phase, slurry phase, gas phase or bulk phase, with polymerisation temperatures ranging from −100° C. to +300° C., and at pressures of atmospheric and above, particularly from 140 to 4100 kPa. If desired, the catalyst can be used to polymerise ethylene under high pressure/high temperature process conditions wherein the polymeric material forms as a melt in supercritical ethylene. Preferably the polymerisation is conducted under gas phase fluidised bed or stirred bed conditions.

Suitable monomers for use in the polymerisation process of the present invention are, for example, ethylene and C₂₋₂₀ α-olefins, specifically propylene, 1-butene, 1-pentene, 1-hexene, 4-methylpentene-1, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, and 1-eicosene. Other monomers include methyl methacrylate, methyl acrylate, butyl acrylate, acrylonitrile, vinyl acetate, and styrene. Preferred monomers for homopolymerisation processes are ethylene and propylene.

The catalysts and process of the invention can also be used for copolymerising ethylene or propylene with each other or with other 1-olefins such as 1-butene, 1-hexene, 4-methylpentene-1, and octene, or with other monomeric materials, for example, methyl methacrylate, methyl acrylate, butyl acrylate, acrylonitrile, vinyl acetate, and styrene.

Irrespective of the polymerisation or copolymerisation technique employed, polymerisation or copolymerisation is typically carried out under conditions that substantially exclude oxygen, water, and other materials that act as catalyst poisons. Also, polymerisation or copolymerisation can be carried out in the presence of additives to control polymer or copolymer molecular weights.

The use of hydrogen gas as a means of controlling the average molecular weight of the polymer or copolymer applies generally to the polymerisation process of the present invention. For example, hydrogen can be used to reduce the average molecular weight of polymers or copolymers prepared using gas phase, slurry phase, bulk phase or solution phase polymerisation conditions. The quantity of hydrogen gas to be employed to give the desired average molecular weight can be determined by simple “trial and error” polymerisation tests.

The polymerisation process of the present invention provides polymers and copolymers, especially ethylene polymers, at remarkably high productivity (based on the amount of polymer or copolymer produced per unit weight of complex employed in the catalyst system). This means that relatively very small quantities of transition metal complex are consumed in commercial processes using the process of the present invention. It also means that when the polymerisation process of the present invention is operated under polymer recovery conditions that do not employ a catalyst separation step, thus leaving the catalyst, or residues thereof, in the polymer (e.g. as occurs in most commercial slurry and gas phase polymerisation processes), the amount of transition metal complex in the produced polymer can be very small.

Slurry phase polymerisation conditions or gas phase polymerisation conditions are particularly useful for the production of high or low density grades of polyethylene, and polypropylene. In these processes the polymerisation conditions can be batch, continuous or semi-continuous. Furthermore, one or more reactors may be used, e.g. from two to five reactors in series. Different reaction conditions, such as different temperatures or hydrogen concentrations may be employed in the different reactors. In the slurry phase process and the gas phase process, the catalyst is generally metered and transferred into the polymerisation zone in the form of a particulate solid either as a dry powder (e.g. with an inert gas) or as a slurry. This solid can be, for example, a solid catalyst system formed from the one or more of complexes of the invention and an activator with or without other types of catalysts, or can be the solid catalyst alone with or without other types of catalysts. In the latter situation, the activator can be fed to the polymerisation zone, for example as a solution, separately from or together with the solid catalyst. Preferably the catalyst system or the transition metal complex component of the catalyst system employed in the slurry polymerisation and gas phase polymerisation is supported on one or more support materials. Most preferably the catalyst system is supported on the support material prior to its introduction into the polymerisation zone. Suitable support materials are, for example, silica, alumina, zirconia, talc, kieselguhr, or magnesia. Impregnation of the support material can be carried out by conventional techniques, for example, by forming a solution or suspension of the catalyst components in a suitable diluent or solvent, and slurrying the support material therewith. The support material thus impregnated with catalyst can then be separated from the diluent for example, by filtration or evaporation techniques. Once the polymer product is discharged from the reactor, any associated and absorbed hydrocarbons are substantially removed, or degassed, from the polymer by, for example, pressure let-down or gas purging using fresh or recycled steam, nitrogen or light hydrocarbons (such as ethylene). Recovered gaseous or liquid hydrocarbons may be recycled to the polymerisation zone.

In the slurry phase polymerisation process the solid particles of catalyst, or supported catalyst, are fed to a polymerisation zone either as dry powder or as a slurry in the polymerisation diluent. The polymerisation diluent is compatible with the polymer(s) and catalyst(s), and may be an alkane such as hexane, heptane, isobutane, or a mixture of hydrocarbons or paraffins. Preferably the particles are fed to a polymerisation zone as a suspension in the polymerisation diluent. The polymerisation zone can be, for example, an autoclave or similar reaction vessel, or a continuous loop reactor, e.g. of the type well-know in the manufacture of polyethylene by the Phillips Process. When the polymerisation process of the present invention is carried out under slurry conditions the polymerisation is preferably carried out at a temperature above 0° C., most preferably above 15° C. The polymerisation temperature is preferably maintained below the temperature at which the polymer commences to soften or sinter in the presence of the polymerisation diluent. If the temperature is allowed to go above the latter temperature, fouling of the reactor can occur. Adjustment of the polymerisation within these defined temperature ranges can provide a useful means of controlling the average molecular weight of the produced polymer. A further useful means of controlling the molecular weight is to conduct the polymerisation in the presence of hydrogen gas which acts as chain transfer agent. Generally, the higher the concentration of hydrogen employed, the lower the average molecular weight of the produced polymer.

In bulk polymerisation processes, liquid monomer such as propylene is used as the polymerisation medium.

Methods for operating gas phase polymerisation processes are well known in the art. Such methods generally involve agitating (e.g. by stirring, vibrating or fluidising) a bed of catalyst, or a bed of the target polymer (i.e. polymer having the same or similar physical properties to that which it is desired to make in the polymerisation process) containing a catalyst, and feeding thereto a stream of monomer at least partially in the gaseous phase, under conditions such that at least part of the monomer polymerises in contact with the catalyst in the bed. The bed is generally cooled by the addition of cool gas (e.g. recycled gaseous monomer) and/or volatile liquid (e.g. a volatile inert hydrocarbon, or gaseous monomer which has been condensed to form a liquid). The polymer produced in, and isolated from, gas phase processes forms directly a solid in the polymerisation zone and is free from, or substantially free from liquid. As is well known to those skilled in the art, if any liquid is allowed to enter the polymerisation zone of a gas phase polymerisation process the quantity of liquid in the polymerisation zone is small in relation to the quantity of polymer present. This is in contrast to “solution phase” processes wherein the polymer is formed dissolved in a solvent, and “slurry phase” processes wherein the polymer forms as a suspension in a liquid diluent.

The gas phase process can be operated under batch, semi-batch, or so-called “continuous” conditions. It is preferred to operate under conditions such that monomer is continuously recycled to an agitated polymerisation zone containing polymerisation catalyst, make-up monomer being provided to replace polymerised monomer, and continuously or intermittently withdrawing produced polymer from the polymerisation zone at a rate comparable to the rate of formation of the polymer, fresh catalyst being added to the polymerisation zone to replace the catalyst withdrawn form the polymerisation zone with the produced polymer.

For typical production of impact copolymers, homopolymer formed from the first monomer in a first reactor is reacted with the second monomer in a second reactor. For manufacture of propylene/ethylene impact copolymer in a gas-phase process, propylene is polymerized in a first reactor; reactive polymer transferred to a second reactor in which ethylene or other comonomer is added. The result is an intimate mixture of a isotactic polypropylene chains with chains of a random propylene/ethylene copolymer. A random copolymer typically is produced in a single reactor in which a minor amount of a comonomer (typically ethylene) is added to polymerizing chains of propylene.

Methods for operating gas phase fluidised bed processes for making polyethylene, ethylene copolymers and polypropylene are well known in the art. The process can be operated, for example, in a vertical cylindrical reactor equipped with a perforated distribution plate to support the bed and to distribute the incoming fluidising gas stream through the bed. The fluidising gas circulating through the bed serves to remove the heat of polymerisation from the bed and to supply monomer for polymerisation in the bed. Thus the fluidising gas generally comprises the monomer(s) normally together with some inert gas (e.g. nitrogen or inert hydrocarbons such as methane, ethane, propane, butane, pentane or hexane) and optionally with hydrogen as molecular weight modifier. The hot fluidising gas emerging from the top of the bed is led optionally through a velocity reduction zone (this can be a cylindrical portion of the reactor having a wider diameter) and, if desired, a cyclone and or filters to disentrain fine solid particles from the gas stream. The hot gas is then led to a heat exchanger to remove at least part of the heat of polymerisation. Catalyst is preferably fed continuously or at regular intervals to the bed. At start up of the process, the bed comprises fluidisable polymer which is preferably similar to the target polymer. Polymer is produced continuously within the bed by the polymerisation of the monomer(s). Preferably means are provided to discharge polymer from the bed continuously or at regular intervals to maintain the fluidised bed at the desired height. The process is generally operated at relatively low pressure, for example, at 10 to 50 bars, and at temperatures for example, between 50 and 120° C. The temperature of the bed is maintained below the sintering temperature of the fluidised polymer to avoid problems of agglomeration.

In the gas phase fluidised bed process for polymerisation of olefins the heat evolved by the exothermic polymerisation reaction is normally removed from the polymerisation zone (i.e. the fluidised bed) by means of the fluidising gas stream as described above. The hot reactor gas emerging from the top of the bed is led through one or more heat exchangers wherein the gas is cooled. The cooled reactor gas, together with any make-up gas, is then recycled to the base of the bed. In the gas phase fluidised bed polymerisation process of the present invention it is desirable to provide additional cooling of the bed (and thereby improve the space time yield of the process) by feeding a volatile liquid to the bed under conditions such that the liquid evaporates in the bed thereby absorbing additional heat of polymerisation from the bed by the “latent heat of evaporation” effect. When the hot recycle gas from the bed enters the heat exchanger, the volatile liquid can condense out. In one embodiment of the present invention the volatile liquid is separated from the recycle gas and reintroduced separately into the bed. Thus, for example, the volatile liquid can be separated and sprayed into the bed. In another embodiment of the present invention the volatile liquid is recycled to the bed with the recycle gas. Thus the volatile liquid can be condensed from the fluidising gas stream emerging from the reactor and can be recycled to the bed with recycle gas, or can be separated from the recycle gas and then returned to the bed.

The method of condensing liquid in the recycle gas stream and returning the mixture of gas and entrained liquid to the bed is described in EP-A-0089691 and EP-A-0241947. It is preferred to reintroduce the condensed liquid into the bed separate from the recycle gas using the process described in our U.S. Pat. No.5,541,270, the teaching of which is hereby incorporated into this specification.

When using the catalysts of the present invention under gas phase polymerisation conditions, the catalyst, or one or more of the components employed to form the catalyst can, for example, be introduced into the polymerisation reaction zone in liquid form, for example, as a solution in an inert liquid diluent. Thus, for example, the transition metal component, or the activator component, or both of these components can be dissolved or slurried in a liquid diluent and fed to the polymerisation zone. Under these circumstances it is preferred the liquid containing the component(s) is sprayed as fine droplets into the polymerisation zone. The droplet diameter is preferably within the range 1 to 1000 microns. EP-A-0593083, the teaching of which is hereby incorporated into this specification, discloses a process for introducing a polymerisation catalyst into a gas phase polymerisation. The methods disclosed in EP-A-0593083 can be suitably employed in the polymerisation process of the present invention if desired.

Although not usually required, upon completion of polymerisation or copolymerisation, or when it is desired to terminate polymerisation or copolymerisation or at least temporarily deactivate the catalyst or catalyst component of this invention, the catalyst can be contacted with water, alcohols, acetone, or other suitable catalyst deactivators a manner known to persons of skill in the art.

Homopolymerisation of ethylene with the catalysts of the invention may produce so-called “high density” grades of polyethylene. These polymers have relatively high stiffness and are useful for making articles where inherent rigidity is required. Copolymerisation of ethylene with higher 1-olefins (e.g. butene, hexene or octene) can provide a wide variety of copolymers differing in density and in other important physical properties. Particularly important copolymers made by copolymerising ethylene with higher 1-olefins with the catalysts of the invention are the copolymers having a density in the range of 0.91 to 0.93. These copolymers which are generally referred to in the art as linear low density polyethylene, are in many respects similar to the so called low density polyethylene produced by the high pressure free radical catalysed polymerisation of ethylene. Such polymers and copolymers are used extensively in the manufacture of flexible blown film.

Propylene polymers produced by the process of the invention include propylene homopolymer and copolymers of propylene with less than 50 mole % ethylene or other alpha-olefin such as butene-1, pentene-1,4-methylpentene-1, or hexene-1, or mixtures thereof. Propylene polymers also may include copolymers of propylene with minor amounts of a copolymerizable monomer. Typically, most useful are normally-solid polymers of propylene containing polypropylene crystallinity, random copolymers of propylene with up to about 10 wt. % ethylene, and impact copolymers containing up to about 20 wt. % ethylene or other alpha-olefin. Polypropylene homopolymers may contain a small amount (typically below 2 wt. %) of other monomers to the extent the properties of the homopolymer are not affected significantly.

Propylene polymers may be produced which are normally solid, predominantly isotactic, poly α-olefins. Levels of stereorandom by-products are sufficiently low so that useful products can be obtained without separation thereof Typically, useful propylene homopolymers show polypropylene crystallinity and have isotactic indices above 90 and many times above 95. Copolymers typically will have lower isotactic indices, typically above 80-85.

Depending upon polymerisation conditions known in the art, propylene polymers with melt flow rates from below 1 to above 1000 may be produced in a reactor. For many applications, polypropylenes with a MFR from 2 to 100 are typical. Some uses such as for spunbonding may use a polymer with an MFR of 500 to 2000.

Peroxide compounds may be added to ethylene or propylene polymers. For ethylene based polymers, peroxides can be used to give cross-linking in the polymer. For the preparation of high MFR propylene polymers, peroxide compounds may be added during extrusion for controlled rheology to increase the melt flow rate of polymer. Peroxide acts to break long polymer chains and has the effect of both increasing MFR and narrowing the molecular weight distribution (Mw/Mn) or polydispersity. A typical reactor polypropylene powder with an MFR of 2 g/10 min. by controlled rheology treatment with peroxide in an extruder may form a polymer with an MFR of 20-40. By varying the type, amount of, and process conditions using, peroxide, the final polymer MFR may be controlled as known in the art.

Depending upon the use of the polymer product, minor amounts of additives are typically incorporated into the polymer formulation such as acid scavengers, antioxidants, stabilizers, and the like. Generally, these additives are incorporated at levels of about 25 to 2000 ppm, typically from about 50 to about 1000 ppm, and more typically 400 to 1000 ppm, based on the polymer.

In use, polymers or copolymers made according to the invention in the form of a powder are conventionally compounded into pellets. Examples of uses for polymer compositions made according to the invention include use to form fibres, extruded films, tapes, spunbonded webs, moulded or thermoformed products, and the like. The polymers may be blown into films, or may be used for making a variety of moulded or extruded articles such as pipes, and containers such as bottles or drums. Specific additive packages for each application may be selected as known in the art. Examples of supplemental additives include slip agents, anti-blocks, anti-stats, mould release agents, primary and secondary anti-oxidants, clarifiers, nucleants, uv stabilizers, and the like. Classes of additives are well known in the art and include phosphite antioxidants, hydroxylamine (such as N,N-dialkyl hydroxylamine) and amine oxide (such as dialkyl methyl amine oxide) antioxidants, hindered amine light (uv) stabilizers, phenolic stabilizers, benzofuranone stabilizers, and the like. Various olefin polymer additives are described in U.S. Pat. Nos. 4,318,845, 4,325,863, 4,590,231, 4,668,721, 4,876,300, 5,175,312, 5,276,076, 5,326,802, 5,344,860, 5,596,033, and 5,625,090.

Fillers such as silica, glass fibers, talc, and the like, nucleating agents, and colourants also may be added to the polymer compositions as known by the art.

The present invention is illustrated in the following Examples and Comparative Examples.

### EXAMPLES

All manipulations were carried out under an atmosphere of nitrogen using standard Schlenk and cannula techniques or in a conventional nitrogen-filled glove box. Solvents were refluxed over an appropriate drying agent, distilled and degassed prior to use. Lithium diisopropylamide was freshly prepared prior to use. To diisopropylamine in THF at −78° C., n-butyl lithium (1 eq.) was added drop wise, solution allowed to warm to 0° C. (15 min.) and then used immediately.

Ligands and procatalysts synthesised

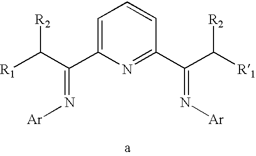

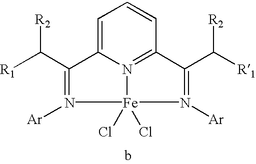

| Compound | R₁ | R′₁ | R₂ | Ar |
|---|---|---|---|---|
| 1 (comparative) | H | H | H | 2,4,6-trimethylphenyl |
| 2 (comparative) | H | H | H | 2,6-diisopropylphenyl |
| 4 | Me | Me | Me | 2,4,6-trimethylphenyl |
| 5 | H | CH₂Ph | H | 2,4,6-trimethylphenyl |
| 6 | CH₂Ph | CH₂Ph | H | 2,4,6-trimethylphenyl |
| 8 | Me | Me | Me | 2,6-diisopropylphenyl |

### Example 1

### Preparation of Ligand 1a

To 2,6diacetylpyridine (10.00 g, 0.061 mol) in the minimum volume of absolute ethanol, 2,4,6-trimethylaniline (2.5eq, 19.95 ml, 0.153 mol) was added with glacial acetic acid (0.1 ml, catalytic) and refluxed until reaction complete by ¹H NMR, 120 h. The solvent was removed, and the solid recrystallised from absolute ethanol to yield the yellow solid of 1a (21.15 g, 87%). MS (CI) m/z 398 [M+H]⁺. ¹H NMR (CDCl₃): δ8.50 (d, 2H,³J(HH) 7.9, Py-Hₘ), 7.95 (t, 1H, Py-Hp), 6.94 (s, 4H, Ar—H), 2.33 (s, 6H, N═CMe), 2.28 (s, 6H, CMe), 2.05 (s, 12H, CMe).

### Example b 2

### Preparation of Ligand 2a

To 2,6-diacetylpyridine (2.00 g, 0.012 mol) in the minimum volume of abs. Ethanol, 2,6-diisobutylaniline (2.5eq, 5.80 ml, 0.030 mol) was added with glacial acetic acid (0.05 ml, catalytic) and refluxed until reaction complete by ¹H NMR, 72 h The solvent was removed, and the solid recrystallised from absolute ethanol to yield the yellow solid of 2a (4.04 g, 70%). MS (CI) m/z 482 [M+H]⁺. ¹H NMR (CDCl₃):δ8.52 (d, 2H,³J(HH) 7.8, Py-Hₘ), 7.94 (t, 1H, Py-Hp), 7.1 (m, 6H, Ar—H), 2.78 (sept, 4H, ³J(HH) 5.6, CHMe₂), 2.28 (s,6H, N═CMe), 1.18 (d, 24H, CHMe₂).

### Example 4

### Preparation of Ligand 4a

To ligand 3a (0.54 g, 1.26 mmol) in THF (30 ml) at −78° C., lithium diisopropylamide (2.2 eq., 2.77 mmol; freshly prepared from diisopropylamine (0.39 ml, 2.77 mmol) and n-butyllithium (1.73 ml, 2.77 mmol, 1.6 M in Hexanes) in THF (5 ml)) was added drop wise. The yellow solution darkened. The solution was allowed to warm to 0° C. with stirring for 2 h. Iodomethane (0.17 ml, 2.77 mmol. 2.2 eq.) was added. The solution was allowed to warm to room temperature and stirred for 18 h to form a yellow solution. The solvent was removed. Diethylether (40 ml) was added, the solution washed with water (3×30 ml), dried over MgSO₄, filtered, and the solvent removed to yield a yellow solid. The product was recrystallised from absolute ethanol to yield 4a (0.41 g, 72%) a yellow solid. MS (CI) m/z 454 [M+H]⁺. ¹H NMR (CDCl₃): δ8.05 (broad, 2H, Py-Hm), 7.47 (broad, 1H, Py-Hp), 6.70 (m, 4H, Ar—H), 2.78 (broad, 2H, N═CCH(CH₃)₂), 2.25 (m, 6H, CMe), 1.90 (m, 12H, CMe), 1.27 (m, 12H, N═CCH(CH₃)₂).

### Example 5

### Preparation of Ligand 5a

To ligand 1a (0.50 g, 1.26 mmol) in THF (30 ml) at −78° C., lithium diisopropylamide (1.1 eq., 1.39 mmol; freshly prepared from diisopropylamine (0.19 ml, 1.39 mmol) and n-butyllithium (0.86 ml, 1.39 mmol, 1.6 M in hexanes) in THF (5 ml)) was added dropwise. The yellow solution darkened. The solution was allowed to warm to 0° C. with stirring for2 h. Benzylbromide (0.18 ml, 1.39mmol, 1.1 eq.) was added. The solution allowed to warm to room temperate and stirred for 18 h to form a yellow solution. The solvent was removed. Diethylether (40 ml) was added, the solution washed with water (3×30 ml). dried over MgSO₄, filtered, and the solvent removed to yield a yellow solid. The product was recrystallised from absolute ethanol to yield 5a (0.49 g, 80%) a yellow solid. MS (CI) m/z 488 [M+H]⁺. ¹H NMR (CDCl₃): δ8.48 (m, 2H, Py-Hm), 7.94 (m, 1H, Py-Hp), 7.20−6.97 (m, 5H N═CCH₂CH₂Ph),6.90 (s, 2H, Ar—H), 6.87 (s, 2H, Ar¹—H), 3.02 (m, 2H, N═CCH₂CH₂Ph), 2.81 (m, 2H, N═CCH₂CH₂Ph), 2.31 (s, 6H, CMe), 2.28 (s, 3H, N═CMe), 2.04 (s, 6H, CMe), 2.02 (s, 6H, CMe¹).

### Example 6

### Preparation of Ligand 6a

To ligand 1a (1.00 g, 2.52 mmol) in THF (50 ml) at −78 ° C., lithium diisopropylamnide (2.2 eq., 5.54 mmol; freshly prepared from diisopropylamine (0.78 ml, 5.53 mmol) and n-butyllithium (3.46 ml, 5.53 mmol, 1.6M in Hexanes) in THF (8 ml)) was added drop wise. The yellow solution darkened. The solution was allowed to warm to 0° C. with stirring for 2 h. Benzylbrumide (0.72 ml, 6.04 mmol, 2.4 eq.) was added and the solution allowed to warm to room temperature and stirred for 18 h to form a yellow solution. The solvent was removed. Diethylether (40 ml) was added, and the product washed with water (3×30 ml), dried over MgSO₄, filtered, and the solvent removed to yield a yellow solid. The product was recrystallised from absolute ethanol to yield 6a (0.88 g, 61%), a yellow solid. MS (CI) m/z 578 [M+H]⁺. MS (CI) m/z 482 [M+H]⁺. ¹H NMR (CDCl₃): δ8.45 (d, 2H, ³J(HH) 7.9, Py-Hm), 7.97 (t, 1H, Py-Hp), 6.90 (s, 4H, Ar—H), 7.26−6.83 (m, 10H N═CCH₂CH₂Ph), 3.06 (m, 4H, N═CCH₂CH₂Ph), 2.78 (m, 4H, N═CCH₂CH₂Ph), 2.31 (s, 6H, CMe), 2.03 (s, 12H, CMe).

### Example 8

### Preparation of Ligand 8a

To ligand 7a (0.50 g, 0.98 mmol) in THF (30 ml) at −78° C., lithium diisopropylamide (2.2 eq., 2.16 mmol; freshly prepared from diisopropylamine (0.30 ml, 2.16 mmol) and n-Butyllithium (1.44 ml, 2.16 mmol, 1.5 M in Hexanes) in THF (5 ml)) was added drop wise. Yellow solution darkens. Solution allowed to warm to 0° C. with stirring for 2 h. Iodomethane (0.13 ml, 2.16 mmol, 2.2 eq.) added. Solution allowed to warm to RT and stirred 18 h to form a yellow solution. Solvent removed. Diethylether (40 ml) added, washed Water (3×30 ml), dried over MgSO₄, filtered, Solvent removed to yield a yellow solid. Product recrystalised form abs. Ethanol to yield 8a (0.37 g, 70%) a yellow solid. MS (CI) m/z 538 [M+H]⁺.]⁺. ¹H NMR (CDCl₃): δ8.00 (broad, 2H, Py-Hu), 7.99 (broad, 1H, Py-Hp), 7.15 (broad, 6H, Ar—H), 2.78 broad, 6H, CHMe₂ and N═CCH(CH₃)₂), 1.25 (broad, 24H, CHMe₂), 0.91 (broad, 6H, N═CCH(CH₃)₂)

### Example 9

### Preparation of 2,6-dibenzoylpyridine

Pyridine dicabonyl dichloride (5 g, 0.0263 mol), anhydrous aluminum trichloride (10.52 g, 0.0789 mol) and anhydrous benzene (150 cm³) were mixed under anhydrous conditions and heated under reflux for four hours with a slow flow of nitrogen over the top of the condenser. The resulting dark red mixture was allowed to cool to room temperature under a slow flow of nitrogen before pouring the mixture onto a dilute hydrochloric acid/ice mixture. The organic layer was separated from the aqueous layer and the aqueous layer was washed with diethyl ether (3×75 cm³). The organic fractions were combined and washed with saturated sodium carbonate (25 cm³) and dried over anhydrous sodium sulphate. The solution was filtered and the liquid volume reduced to approximately 5 cm³ and petroleum ether 40-60 (150 cm³) added causing a white solid to crash out of solution. This was filtered off and washed with cold petroleum ether 40-60 (25 cm³) and dried in vacuo. Yield: 7.0 g, (93%). ¹H NMR (CDCl₃): 8.29 (d, 2H, Py-Hₘ); 8.15 (complex, 5H, Ar—Hₒ & Py-Hₚ); 7.58 (tt, 2H, Ar—Hₚ); 7.42 (t, 4H, Ar—Hₘ).

### Example 9

### Preparation of Ligand 9a

2,6-dibenzoylpyridine (2 g, 0.00696 mol), 2,4,6-trimethylaniline (2.82 g, 2.93 cm³, 0.021 mol), p-toluenesulphonic acid (0.1 g) and toluene (200 cm³) were placed in a flask fitted with a Dean-Stark head and refluxed under a slow flow of nitrogen until the reaction was complete by tlc, 120 h. The solvent was removed to yield a yellow solid which was washed with cold methanol and dried in vacuo. Yield: 3.23 g (89%).

### Example 10

### Preparation of 2,6-di(2,4dimethylphenyl)pyridine

Pyridine dicarbonyl dichloride (5 g, 0.0263 mol), anbydrous aluminum trichloride (10.52 g, 0.0789 mol) and anhydrous m-xylene (150 cm³) were mixed under anhydrous conditions and heated under reflux for four hours with a slow flow of nitrogen over the top of the condenser. The resulting dark red mixture was allowed to cool to room temperature under a slow flow of nitrogen before pouring the mixture onto a dilute hydrochloric acid/ice mixture. The organic layer was separated from the aqueous layer and the aqueous layer was washed with diethyl ether (3×75 cm³). The organic fractions were combined and washed with saturated sodium carbonate (25 cm³) and dried over anhydrous sodium sulphate. The solution was filtered and the liquid volume reduced to approximately 5 cm³ and petroleum ether 40-60 (150 cm³) added causing a white solid in the form of needles to form in the solution. These was filtered off and washed with cold petroleum ether 40-60 (25 cm³) and dried in vacuo. Yield: 8.6 g, (95%). ¹H NMR (CDCl₃): 8.18 (d, 2H, Py-Hₘ); 8.03 (t, 1H, Py-Hₚ); 7.39 (d, 2H, Ar—Hₚ); 6.99 (s, 2H, Ar—Hₘ);6.88 (d, 2H, Ar—Hₘ)2.33 (s, 6H, CH₃); 2.32 (s, 6H, CH₃).

### Example 11

### Preparation of Procatalysts 1b and 2b (Comparative)

FeCl₂ (1 equiv) was dissolved in hot n-butanol at 80° C. A suspension of ligand 1a or 2a (1 equiv) in n-butanol was added dropwise at 80° C. The reaction mixture turned blue. After stirring at 80° C. for 15 minutes the reaction was allowed to cool down to room temperature. The reaction volume was reduced to a few ml, and petroleum ether (40/60) was added to precipitate the product (a blue powder), which was subsequently washed three times with 10 ml petroleum ether (40/60).

### Preparation of Procatalysts 3b to 9b

To the appropriate ligand 3a to 9a, anhydrous iron (II) chloride (1 eq.) and n-butanol were added and heated at 80° C. for 18 hours to produce a blue precipitate. Solvent was removed, and the solid washed with diethylether (3×20 ml) and then dried to yield blue solids (green solid for 9b) of procatalysts:

1b: (64%). MS (FAB⁺) m/z 523 [M]⁺, 488 [M-Cl]⁺, 453 [M-Cl₂]⁺;

2b: (81%). MS (FAB⁺) m/z 607 [M]⁺, 572 [M-Cl]⁺, 482 [M-FeCl₂)³⁰ ;

4b: (94%). MS (FAB⁺) m/z 579 [M]⁺, 544 [M-Cl]⁺, 509 [M-2Cl]⁺;

5b: (87%). MS (FAB⁺) m/z 613 [M]⁺, 578 [M-Cl]⁺, 543 [M-2Cl]³⁰;

6b: (79%). MS (FAB⁺) m/z 703 [M]⁺, 668 [M-Cl]⁺, 633 [M-2Cl]⁺;

8b: (81%). MS (FAB⁺) m/z 663 [M]⁺, 628 [M-Cl)⁺.

9b: MS (FAB⁺) m/z 648 [M]⁺, 613 [M-Cl]⁺

### Preparation of Procatalyst 10b

2,6-di(2,4-dimethylphenyl)pyridine (2 g, 0.00582 mol), 2,4,6-trimethylamine (2.36 g, 2.45 cm³, 0.0175 mol), p-toluenesulphonic acid (0.1 g), anhydrous iron (II) chloride (0.738 g, 0.00582 mol) and toluene (200 cm³) were placed in a flask fitted with a Dean-Stark head and refluxed under a slow flow of nitrogen for 432 h. The resulting green solid was filtered off, washed with hexanes (3×15 cm³) and dried in vacuo.

Yield: 3.28 g (80%). MS (FAB⁺) m/z 703 [M]⁺, 668 [M-Cl]³⁰

### Example 12

### Polymerisation of Ethylene

Polymerisations were performed in a 1 litre autoclave.

### General Polymerisation Procedure

The 1 litre stainless steel reactor was baked out under a nitrogen flow for 1 h at 85° C. and subsequently cooled to 50° C. Isobutane (0.51) and triisobutylaluminum (2.0 ml, 1.0 M in heaxane) were introduced into the reactor and stirred at the reaction temperature for 0.5 hour. Ethylene (4 bar) was introduced into the reactor by back pressure of nitrogen. To the catalyst (5.0 μmol) dissolved in toluene (19.6 ml), MAO (100 eq., 0.4 ml, 0.5 mmol, 10% w/w in toluene) was added to form an orange solution. A fraction of the solution (2.0 ml, 0.5 μmol) was then injected into the reactor under nitrogen. The reactor pressure was maintained constant throughout the polymerisation run by computer controlled addition of ethylene. Polymerisations were performed for 60 minutes. Polymerisations were terminated by venting off volatiles. The reactor contents were isolated, washed with aqueous HCl, methanol and dried under vacuum.

Polymerisation data

| | | | | | | | | | 13C | | |
|---|---|---|---|---|---|---|---|---|---|---|---|
| | | | GPC | | | | 1H NMR | | NMR | | |
| | Yield | | Mₙ | M_{w} | | Mpk | Sat | Vinyl | Sat | Vinyl | iPr |
| Catal. | PE | Activity^{φ} | (000) | (000) | M_{w}/Mₙ | (000) | Ends | Ends | Ends | Ends | Ends |
| 1b* | 32.1 | 16,050 | 9.4 | 208 | 22 | 47 | | | 1.1 | 0.7 | 0.6 |
| 2b* | 9.6 | 4,780 | 53 | 500 | 9.5 | 285 | | | | | |
| 4b | 35.6 | 17,800 | 12 | 470 | 38.0 | 82 | | | 0.6 | 0.2 | 0.6 |
| 5b | 40.2 | 20,075 | 6.7 | 235 | 34.9 | 25 | | 1.72 | 1.0 | 0.6 | 0.9 |
| 6b | 32.5 | 16,250 | 6.5 | 197 | 30.4 | 26 | | 1.69 | 1.0 | 0.4 | 0.5 |
| 8b | 6.0 | 3,020 | 24 | 557 | 22.8 | 263 | 0.73 | 0.84 | 0.7 | 0.4 | 0.0 |

*comparative example
φ Units = g mmol⁻¹ h⁻¹ bar⁻¹

The above results show that polymers produced using the catalysts of the invention generally have higher polydispersities (M_{w}/Mₙ) than those produced using corresponding compounds from the prior art: compare 1b with 4b to 6b, and 2b with 8b. This unexpected effect results in improved processing properties.

### Example 13

### Preparation of Supported Catalyst

Silica support (30 g, ES70X supplied by Crosfield) was heated under flowing nitrogen (100 ml/min) at 200° C. for 16 hours. In an inert atmosphere a sample of this silica (20 g) was placed in a Schlenk tube and 34 ml of 10% methylaluminoxane in toluene (“MAO” supplied by Witco) was added to it to form a slurry. The slurry was heated for 1 hour at 50° C. with periodic shaking to thoroughly mix, allowed to settle and the supernatant liquid above the silica removed using cannular tubing. The silica/MAO was then pumped to dryness under vacuum at 50° C. until fluidisation ceased. To a sample of this silica supported MAO (3.0 g) at room temperature was added a toluene(25 ml) slurry of iron complex 6b (0.047 g, 0.067 mmol). The mixture was placed in a waterbath at 50° C. and occasionally shaken over a 1 hour period to ensure homogeneity. The supernatant solution was removed and the produced silica-supported MAO/Fe complex dried under vacuum at 50° C. until fluidisation ceased.

### Example 14

### Supported Methylaluminoxane Preparation

ES70X silica calcined at 200° C. (27.19 g) was added to a RB Schlenk flask and slurried in dry toluene (80 cm³). A 10% w/w solution of methylaluminoxane (MAO) in toluene from Witco (39.65 cm³, 0.0706 mol MAO) was then slowly added to the toluene/silica slurry with continuous stirring and the mixture heated to 80° C. for 60 minutes after the addition of the MAO was completed. The excess toluene was decanted off and the MAO/silica dried in vacuo until all signs of fluidisation had ceased.

### Example 15

### Supported Catalyst 15 from Complex 1b (Comparative)

The preparation of Fe complexes and the silica supported methylaluminoxane are described above. 1b (0.0262 g, 0.00005 mol) was slurried in dried toluene (5 cm³) and added to a slurry silica/MAO (2.29 g) in toluene (7 cm³). The resulting mixture was heated for one hour at 80° C. with periodic agitation. The now clear supernatant was decanted off and the silica/MAO/Fe complex was dried in vacuo until all signs of fluidisation stopped to leave a beige free flowing solid. Analysis of the catalyst gave a nominal composition of 0.12% w/w Fe and 12.7% w/w MAO.

### Example 16

### Supported Catalyst 16 from Complex 9b

The preparation of Fe complexes and the silica supported methylaluminoxane are described above. 9b (0.0325 g, 0.00005 mol) was slurried in dried toluene (5 cm³) and added to a slurry silica/MAO (2.29 g) in toluene (7 cm³). The resulting mixture was heated for one hour at 80° C. with periodic agitation. The now clear supernatant was decanted off and the silica/MAO/Fe complex was dried in vacuo until all signs of fluidisation stopped to leave a pink free flowing solid. Analysis of the catalyst gave a nominal composition of 0.12% w/w Fe and 12.7% w/w MAO.

### Example 17

### Supported Catalyst 17 (from Complex 10b)

The preparation of Fe complexes and the silica supported methylaluminoxane are described above. 10b (0.0354 g, 0.00005 mol) was slurried in dried toluene (5 cm³) and added to a slay silica/MAO (2.30 g) in toluene (7 cm³). The resulting mixture was heated for one hour at 80° C. with periodic agitation. The now clear supernatant was decanted off and the silica/MAO/Fe complex was dried in vacuo until all signs of fluidisation stopped to leave a pink five flowing solid. Analysis of the catalyst gave a nominal composition of 0.12% w/w Fe and 12.7% w/w MAO.

### Example 18

### Slurry Phase Polymerisation

A litre reaction vessel was heated under flowing nitrogen (2 l/min) for 30 minutes at 90° C. The vessel was purged with nitrogen (3×10 bar) before being sealed and cooled to 40° C. Triisobutyl aluminum (3 ml×1M in hexanes) was added to the reactor followed by 500 ml of isobutane. The reactor was heated to 80° C. causing the pressure to increase to 14.3 bar. Ethylene was added to give 22.3 bar total pressure. The supported catalyst of example 11 above (0.102 g, slurried in 5 ml toluene) was injected into the reactor using nitrogen over-pressure causing the pressure to rise to 22.5 bar. The reactor temperature was maintained at 80° C., the pressure held constant by feeding ethylene as required and polymerisation was allowed to continue for 60 minutes. 75 g of polymer was recovered. Analysis of the polymer by GPC indicated Mw and Mn to be 525000 and 26000 respectively. HLMI 1.53, MI 0.014, MFR 111.

A comparable slurry phase polymerisation using a supported catalyst comprising iron complex 1b (comparative) gave Mw and Mn of 346000 and 25000 respectively.

### Example 19

### Gas Phase Polymerisation

The reagents used in the polymerisation tests were: hydrogen Grade 6.0 (supplied by Air Products): ethylene Grade 3.5 (supplied by Air Products): and methylaluminium (2M in hexanes, supplied by Aldrich). A 3 litre reactor was heated to 80° C. before being pressured to 10 bar with nitrogen and vented to 1 bar. The pressure purge cycle was repeated 8 times before powdered sodium chloride charge powder (300 g, predried under vacuum, 160° C., >4 hours) was added under a stream of nitrogen. The sodium chloride was used as a fluidisable/stirable start-up charge powder for the gas phase polymerisation. Trimethyl aluminum (4 ml, 2 molar in hexanes) was added to the reactor and was boxed in under nitrogen (1.5 bar). The alkyl aluminum was allowed to scavenge for poisons in the reactor for between 2 and 3 hours before being vented using 8×10 bar nitrogen purges. The gas phase composition to be used for the polymerisation was introduced into the reactor and preheated to 78° C. prior to injection of the catalyst composition. The supported catalyst of Example 11 (0.20 g) was injected under nitrogen and the temperature then adjusted to 80° C. The polymerisation tests were allowed to continue for 1 hour before being terminated by purging the reactants from the reactor with nitrogen and reducing the temperature to <30° C. The produced polymer was washed with water to remove the sodium chloride, then with acidified methanol (50 ml HCl/2.5 litres methanol) and finally with water/ethanol (4:1 v/v). The polymer was dried under vacuum, at 40° C., for 16 hours. The polymerisation tests were carried out at a polymerisation temperature of 80° C. and at an ethylene pressure of 8 bar. Analysis of the polymer gave HLMI 1.338, MI 0.018, MFR 74.

A comparable gas phase polymerisation using a supported catalyst comprising iron complex 1b gave HLMI 4.716, MI 0.077, MFR 61.

### Example 20

### Gas Phase Polymerisation

The reagents used in the polymerisation tests were: hydrogen Grade 6.0 (supplied by Air Products): ethylene Grade 3.5 (supplied by Air Products): and trimethylaluminium (2M in hexanes, supplied by Aldrich). A 3 litre reactor was heated to 80° C. before being pressured to 10 bar with nitrogen and vented to 1 bar. The pressure purge cycle was repeated 8 times before powdered sodium chloride charge powder (300 g, predried under vacuum, 160° C., >4 hours) was added under a stream of nitrogen. The sodium chloride was used as a fluidisable/stirable start-up charge powder for the gas phase polymerisation. Trimethylaluminium (4 ml, 2 molar in hexanes) was added to the reactor and was boxed in under nitrogen (1.5 bar). The alkyl aluminum was allowed to scavenge for poisons in the reactor for between 2 and 3 hours before being vented using 8×10 bar nitrogen purges. The gas phase composition to be used for the polymerisation was introduced into the reactor and preheated to 87° C. prior to injection of the catalyst composition. The catalyst (0.05-0.22 g) was injected under nitrogen and the temperature then adjusted to 90° C. The polymerisation tests were allowed to continue for 1 hour before being terminated by purging the reactants from the reactor with nitrogen and reducing the temperature to <30° C. The produced polymer was washed with water to remove the sodium chloride, then with acidified methanol (50 ml HCl/2.5 litres methanol) and finally with water/ethanol (4:1 v/v). The polymer was dried under vacuum, at 40° C., for 16 hours. The polymerisation tests were carried out at a polymerisation temperate of 90° C. and at an ethylene pressure of 16 bar and a hydrogen pressure of 1.6 bar. The polymerisation conditions and catalyst activities re set out in the following Table.

| | | | GPC | | | | MFR | | |
|---|---|---|---|---|---|---|---|---|---|
| Cat | Yield | Activity | Mₙ | M_{w} | M_{w}/Mₙ | Mₚₑₐₖ | MI | HLMI | HLMI/MI |
| 15 (comp) | 154 | 2238 | 11000 | 194,000 | 17.0 | 26000 | 0.269 | 17.24 | 64 |
| 16 | 26 | 773 | 7000 | 237,000 | 35.6 | 14000 | 0.366 | 43.54 | 119 |
| 17 | 37 | 509 | 62000 | 1,230,000 | 19.7 | 678000 | — | — | — |

These results show that catalyst 16 of the invention gives a polydispersity (M_{w}/Mₙ) about twice that of the corresponding prior art catalyst under identical conditions. Although the polydispersity produced by 17 is not in fact much higher than that of 15, this is due to a completely unexpected exceptionally high value of M_{w}.

1. Nitrogen containing transition metal complex having the following Formula (I) 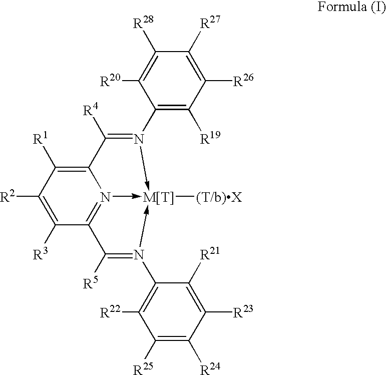
wherein M is Fe[II],Fe[III],Co[I],Co[II], Co[III], Mn[I], Mn[II], Mn[III], Mn[IV], Ru[II], Ru[III], or Ru[IV]; X represents an atom or group covalently or ionically bonded to the transition metal M; T is oxidation state of the transition metal M and b is the valency of the atom group X; R¹, R², R³, R⁴, R⁵, R¹⁹, R²⁰, R²¹, R²², R²³, R²⁴, R²⁵, R²⁶, R²⁷ and R²⁸ are independently selected from hydrogen, halogen, hydrocarbyl, subsisted hydrocarbyl, heterohydrocarbyl or substituted, heterophydrocarbyl; when any two or more of R¹ R², R³, R⁴ and R⁵ and hydrocarbyl, substituted hydrocarbyl, heterohydrocarbyl or substituted heterohydrocarbyl, said two or more can be linked to form one or more cyclic substituents;
characterised in that at least one of R⁴ and R⁵ is a hydrocarbyl group having at least two carbon atoms.

2. Complex according to claim 1 wherein at least one of R⁴ and R⁵ has from 3 to 10 carbon atoms.

3. Complex according to claim 2 wherein at least one and preferably both of R⁴ and R⁵ is isopropyl, t-butyl phenyl, 2,4-dimethyl phenyl or CH₂CH₂Ph.

4. Complex according to any preceding claim wherein R¹, R², R³, R⁴, R⁵, R¹⁹, R²⁰, R²¹, R²², R²³, R²⁴, R²⁵, R²⁶ R²⁷ and R²⁸ are each independently selected from hydrogen and C₁ to C₈ hydrocarbyl; preferably methyl, ethyl, n-propyl, n-butyl, n-hexyl, n-octyl, phenyl and benzyl.

5. Complex according to any preceding claim wherein R²⁴ and R²⁷ are either both halogen or at least one of them has two or more carbon atoms.

6. Complex according to any preceding claim wherein R¹⁹, R²⁰, R²¹ and R²² are each independently selected from methyl, ethyl, n-propyl, iso-propyl, n-butyl, sec-butyl, tert-butyl, n-pentyl, neopentyl, n-hexyl, 4methylpentyl, n-octyl, phenyl and benzyl.

7. Complex according to any preceding claim wherein the transition metal M is Fe(II), Fe(III) or Co(II).

8. Complex according to any preceding claim wherein X is selected firm halide, sulphate, nitrate, thiolate, thiocarboxylate, BF₄⁻, PF₆⁻, hydride, hydrocarbyloxide, carboxylate, hydrocarbyl, substituted hydrocarbyl and heterohydrocarbyl, and β-diketonates.

9. Complex according to claim X wherein X is selected from chloride, bromide, methyl, ethyl, propyl, butyl, octyl, decyl, phenyl, benzyl, methoxide, ethoxide, isopropoxide, tosylate, triflate, formate, acetate, phenoxide and benzoate.

10. Comnplex according to any preceding claim which comprises
2,6bis[1-(2,4,6 trimethylphenyliine) 3-phenylpropyl]pyridine iron dichloride, 2,6 bis[1-(2,6 diisopropylphenylimine) 3-phenylpropyl]pyridine iron dichloride, 2,6 bis[1-(2,4,6 trimethylphenylimine) propyl]pyridine iron dichloride, 2,6 bis[1-(2,6 diisopropylphenylimine) propyl]pyridine iron dichloride, 2,6 bis[1-(2,4,6 trimethylphenylimine) 2-methylpropyl]pyridine iron dichloride, 2,6bis[1-(2,6 diisopropylphenylimine) 2-methylpropyl]pyridine iron dichloride, 2,6 bis[1-(2,6 dimethyl,4-tertbutylphenylimine) 3-phenylpropyl]pyridine iron dichloride, 2,6 bis[1-(2,6 dimethyl,4-bromophenylimine) 3-phenylpropyl]pyridine iron dichloride, 2,6 bis[1-(2,4,6 trimethylphenylimine) 3-phenylpropyl]pyridine iron dibromide, 2,6bis[1-(2,6 diisopropylphenylimine) 3-phenylpropyl]pyridine iron dibromide, 2-[1- (2,4,6 trimethylphenylimine) 3-phenylpropyl[-6-[1-(2,4,6 trimethylphenylimine) ethyl]pyridine iron dichloride, 2-[1-(2,6 diisopropylphenylimine) 3-phenylpropyl]- 6-[(2,6 diisopropylphenylimine)ethyl]pyridine iron dichloride, 2,6 bis[1-(2,4,6 trimethylphenylimine) 3-phenylpropyl]pyridine cobalt dichloride, 2,6 bis[1-(2,6 diisopropylphenylimine) 3-phenylpropyl]pyridine cobalt dichloride, 2,6 bis[1-(2,4,6 trimethylphenylimine) propyl]pyridine cobalt dichloride, 2,6 bis[1-(2,6 diisopropylphenylimine) propyl]pyridine cobalt dichloride, 2,6 -bis-[1-(2, 4, 6 trimethylphenylimine) 2-methylpropyl]pyridine cobalt dichloride, or 2,6 bis[1-(2,6 diisopropylphenylimine) 2-methylpropyl]pyridine cobalt dichloride, 2,6-bis-[1-(2,4,6-trimethylphenylimino)-1-(2,4-dimethylphenyl)methyl]pyridine iron dichloride, 2,6-bis-[1-(2,4,6-trimethylphenylimino)-1- phenylmethyl]pyridine iron dichloride.

11. Polymerisation catalyst comprising
(1) a complex as defined in any preceding claim, and
(2) an activating quantity of at least one activator compound.

12. Catalyst according to claim 11 wherein the activator is selected from organoaluminium compounds, hydrocarbylboron compounds and salts of a cationic oxidising agent and a non-coordinating compatible anion.

13. Catalyst according to claim 12 wherein the activator is selected from triethylaluminium (TMA), triethylaluminium (TEA), tri-isobutylaluminium (TIBA), tri-n-octylaluminium, methylaluminium dichloride, ethylaluminium dichloride, dimethylaluminium chloride, diethylaluminium chloride, ethylaluminiumsesquichloride, methylaluminiumsesquichloride, and alumoxanes.

14. Catalyst according to any one of claims 11 to 13, further comprising a neutral Lewis base.

15. Catalyst according to claim 14 wherein the neutral Lewis base is selected from alkenes (other than 1-olefins) or alkynes, primary, secondary and tertiary amines, amines, phosphoramides, phosphines, phosphites, ethers, thioethers, nitriles, esters, ketones, aldehydes, carbon monoxide and carbon dioxide, sulphoxides, sulphones and boroxines.

16. Catalyst according to any one of claim 1 to 15 which is supported on a support material comprising silica, alumina, MgCl₂ or zirconia, or on a polymer or prepolymer comprising polyethylene, polypropylene, polystyrene, or poly(aminostyrene).

17. Catalyst according to any one of claims 11 to 16 which comprises more than one complex as defined in any of claims 1 to 13, or a complex as defined in any of claims 1 to 13 plus a further tridentate nitrogen-containing Fe or Co complex, which is preferably 6-diacetylpyridinebis(2,4,6-trimethyl anil)FeCl₂.

18. Catalyst according to any one of claims 11 to 16 which comprises a complex as defined in any of claims 1 to 10 plus a further catalyst suitable for the polymerisation of 1-olefins, preferably a Ziegler-Natta catalyst system, metallocene-based catalyst, monocyclopentadienyl- or constrained geometry based catalyst, or heat activated supported chromium oxide catalyst.

19. Process for the polymerisation or copolymerisation of 1-olefins, comprising contacting a monomeric olefin under polymerisation conditions with a complex or catalyst as defined in any preceding claim.

20. Process according to claim 19 comprising the steps of:
a) preparing a prepolymer-based catalyst by contacting one or more 1 -olefins with a catalyst, and
b) contacting the prepolymer-based catalyst with one or more 1-olefins, wherein the catalyst is as defined in any of claims 11 to 18.

21. Process according to claim 19 or 20 wherein tie polymerisation is conducted in the presence of hydrogen as a molecular weight modifier.

22. Process according to any one of claims 19 to 21 wherein the polymerisation conditions are solution phase, slurry phase or gas phase.

23. Process according to claim 22 wherein the polymerisation is conducted under gas phase fluidised bed conditions.

24. Process according to claim 22 wherein the polymerisation is conducted in slurry phase in an autoclave or continuous loop reactor.

25. Use of a complex as defined in any of claims 1 to 10 as a catalyst for the polymerisation of 1-olefins.
